(19) United States
(12) Patent Application Publication
(10) Pub. No.: US 2003/0072488 A1
(43) Pub. Date: Apr. 17, 2003

(54) Apparatus and method for recognizing objects in a digital image and for performing one or more predetermined functions according to recognized objects

(75) Inventors: Eric Lawrence Barsness, Pine Island, MN (US); John Matthew Santosuosso, Rochester, MN (US)

Correspondence Address: MARTIN & ASSOCIATES, LLC, P O BOX 548, CARTHAGE, MO, 64836-0548, US

(73) Assignee: International Business Machines Corporation, Armonk, NY

(21) Appl. No.: 09/977,649

(22) Filed: Oct. 15, 2001

(51) Int. Cl. G06K 9/00

(52) U.S. Cl. 382/181

(57) ABSTRACT

An apparatus and method allows one or more objects to be defined, and one or more corresponding functions to be defined for one or more of the defined objects. An object recognition processor processes digital images, looking for the defined objects. For each defined object that is found in the digital image, a corresponding function is performed. In one specific example of the preferred embodiments, digital images of people's faces are defined as objects. Digital images are processed to see if any of the objects (faces) are present in the digital image. If an object is recognized, an e-mail message is automatically generated with a distribution list that is defined by the recognized object or objects. In this e-mail example, the distribution list will be a superset of the specified distribution lists for all recognized objects. Thus, a digital image that includes grandpa, grandma, and a grandson may be automatically sent to the recipients defined for each of these recognized objects. In this manner the process of processing digital images is greatly enhanced according to objects that are recognized in the digital image.

### BACKGROUND OF THE INVENTION

1. Technical Field

This invention generally relates to apparatus and methods for digital images, and more specifically relates to an apparatus and method for processing a digital image and performing some predetermined function in response to recognizing one or more defined objects in the digital image.

2. Background Art

Photography has been popular for many decades as a way to preserve the past in the form of photographs. Modern developments in photography have added digital cameras that generate an image in electronic form instead of using film. Most digital cameras include an array of charge-coupled devices (CCDs) or other sensors that each record the color and intensity of light that strikes it when a digital photograph is taken. Each CCD or sensor typically makes up one “pixel” in a bit-map of thousands or millions of pixels that collectively define a digital image.

One advantage of digital photography is the ability to store digital images in electronic form, usually as files. This allows traditional file management techniques to be used to store and retrieve digital images. In the prior art, digital cameras typically record digital images on a recordable media, such as a floppy disk or a memory stick that is made of flash electronically erasable programmable read-only memory (Flash EEPROM). The digital images stored in the camera may then be loaded into a computer, either by placing the recordable media in a reader coupled to the computer, or by coupling the digital camera to the computer via a suitable cable and transferring all the images from the digital camera to the computer's hard disk drive. Most modern digital cameras, such a digital cameras manufactured by the Sony Corporation, assign sequential identifiers to digital images. Thus, the first image taken by the digital camera may be identified as “Dsc00001.jpg”, the second image as “Dsc00002.jpg”, etc. The names of these digital images are numerical and are assigned automatically by the digital camera. As a result, after the images are downloaded to a computer, the user must then open each image, determine what is in the image, and determine where to store the image. The user may also rename the image to reflect the contents of the image. Let's assume, for example, that a user defines a directory “people” in the PC's file system, with subdirectories for different people of interest. Let's also assume that the user defines directories for “football”, “landscapes”, “sunsets”, “cars”, and “other”. After downloading a batch of images from a digital camera, the user generally must open the image, visually determine what is in the image, and store the image in the appropriate directory. In addition, if the user wants to more specifically identify the contents of the image, the user may change the name of the image from a numerical designator (such as “Dsc00002.jpg”) to something more descriptive, such as “Katie—Christmas 2000.jpg”.

One of the benefits of using a digital camera to take digital pictures (or images) is that these digital images may be e-mailed to friends and family at no expense. However, the process for e-mailing digital pictures is still a manual process. A digital image may be attached to an e-mail message and sent to specified recipients. E-mail distribution lists may be defined that avoid the need to manually enter each recipient. However, the e-mail message itself must still be manually assembled. In other words, for a mother to send digital images of her children to her parents (the grandparents), she must first generate a new e-mail message, identify her parents as the recipient (or recipients), attach each one of the digital images to be sent, and send the e-mail message.

We see from the discussion above that the process of e-mailing a digital image takes many separate, distinct, and manual steps in the prior art. Without a way to automate the process for e-mailing digital images, users will be forced to use the highly manual process described above.

### DISCLOSURE OF INVENTION

According to the preferred embodiments, one or more objects are defined, and one or more corresponding functions are defined for one or more of the defined objects. An object recognition processor processes digital images, looking for the defined objects. For each defined object that is found in the digital image, a corresponding function is performed. In one specific example of the preferred embodiments, digital images of people's faces are defined as objects. Digital images are processed to see if any of the objects (faces) are present in the digital image. If an object is recognized, an e-mail message is automatically generated with a distribution list that is defined by the recognized object or objects. In this e-mail example, the distribution list will be a superset of the specified distribution lists for all recognized objects. Thus, a digital image that includes grandpa, grandma, and a grandson may be automatically sent to the recipients defined for each of these recognized objects. In this manner the process of processing digital images is greatly enhanced according to objects that are recognized in the digital image.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a prior art digital camera coupled to a personal computer;

FIG. 2 is a flow diagram of a prior art method for generating digital images and transferring the digital images to a personal computer;

FIG. 3 is a flow diagram of a prior art method for sending a digital image as an attachment to an e-mail message;

FIG. 4 is a block diagram of a system in accordance with the preferred embodiments;

FIG. 5 is a flow diagram of a method in accordance with the preferred embodiments for defining objects to look for in digital images and for defining one or more corresponding functions for one or more of the defined objects;

FIG. 6 is a flow diagram of a method in accordance with the preferred embodiments for processing a digital image for defined objects and for performing corresponding function(s) when a defined object is recognized in the digital image;

FIG. 7 is a flow diagram of one sample method for step 620 in FIG. 6 in accordance with the preferred embodiments;

FIG. 8 is a flow diagram of another sample method for step 620 in FIG. 6 in accordance with the preferred embodiments;

FIG. 9 is a flow diagram of one sample method for step 620 in FIG. 6 in accordance with the preferred embodiments;

FIG. 10 is a flow diagram of one sample method for step 620 in FIG. 6 in accordance with the preferred embodiments;

FIG. 11 is a flow diagram of one sample method for step 620B in FIG. 8 in accordance with the preferred embodiments;

FIG. 12 is a flow diagram of another sample method for step 620B in FIG. 8 in accordance with the preferred embodiments;

FIG. 13 is a block diagram of a system 1300 in accordance with one specific implementation in accordance with the preferred embodiments that automatically generates and sends an e-mail message that includes digital images as a result of recognizing one or more defined objects in a digital image;

FIG. 14 is a flow diagram of a method for defining objects to search for in a digital image with corresponding e-mail distribution lists for the system of FIG. 13;

FIG. 15 is a flow diagram of a method for processing images and automatically sending one or more e-mails when a defined object is recognized in a digital image;

FIG. 16 is a block diagram of a sample digital image;

FIG. 17 is a table showing defined e-mail distribution lists that correspond to defined objects; and

FIG. 18 is a table showing the resulting e-mail distribution list that results from processing the digital image of FIG. 16 in accordance with the methods of FIG. 15 and the e-mail distribution lists in FIG. 17.

### BEST MODE FOR CARRYING OUT THE INVENTION

1.0 Overview

The present invention relates to digital images. For those not familiar with digital images or methods used to generate and manipulate digital images, this Overview section will provide background information that will help to understand the present invention.

### Known Digital Cameras and Systems

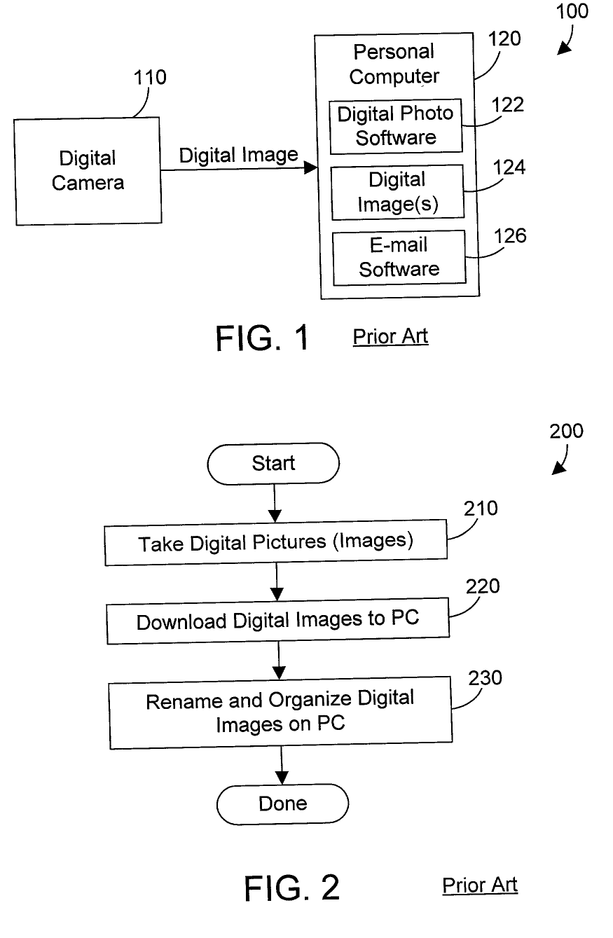

FIG. 1 illustrates a prior art system 100 that includes a digital camera 110 coupled to a personal computer 120. As is known in the art, digital camera 110 may be used in a stand-alone mode (separate from personal computer 120) to capture digital images (i.e., to take digital pictures). The specific configuration in FIG. 1 assumes that the digital camera 110 may be directly coupled to personal computer 120 via a cable or wireless connection, such as via a serial port, as is known in the art. Once coupled together, personal computer 120 may execute digital photo software 122 that downloads one or more digital images 124 from the digital camera and stores the digital images in the PC's memory. As discussed above in the Background section, a user typically must rename the digital images and manually store the digital images in locations that facilitate easily locating and identifying each digital image in the future.

Personal computer 120 may also execute e-mail software 126. A user may create an e-mail message using e-mail software 126, and may then e-mail any digital image 124 to specified recipients. While e-mail software 126 typically includes the ability to define distribution lists, there is currently no known way for e-mail software 126 to automatically determine to whom a digital image should be sent based on the contents of the digital image.

Referring now to FIG. 2, a prior art method for the system of FIG. 1 begins by a user taking digital pictures or images (step 210) using the digital camera 110. The digital images are then downloaded to the personal computer (step 220). Downloading digital images may occur in any suitable fashion. Known methods include removing recordable media from the digital camera and placing the recordable media in a reader coupled to the personal computer, or coupling the digital camera to the personal computer via a cable or wireless link for serial transmission of the digital images between the digital camera and the personal computer. Once the digital images 124 have been downloaded to the personal computer 120, the digital images 124 are typically renamed and organized into folders (step 230) to allow for organization of the digital images that will lead to easy retrieval and use of the images in the future. Step 230 is similar to organizing papers in files and files in a filing cabinet for efficient retrieval when needed at a later time.

### Known Method for Sending Digital Image(s) via E-Mail

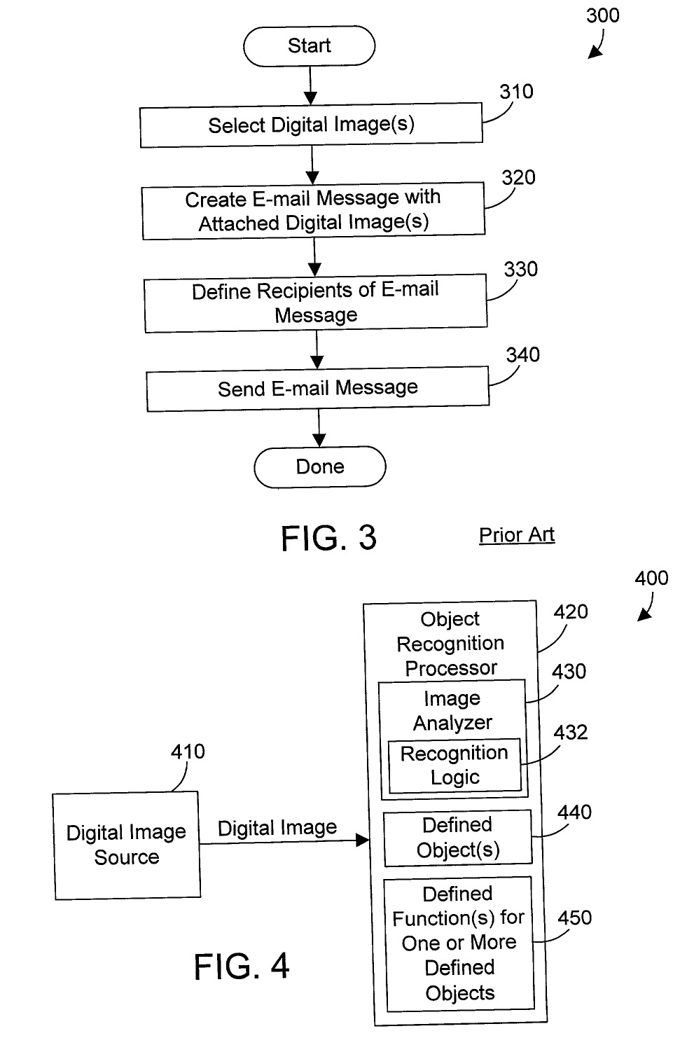

In the prior art, there is no known link in function between programs that process digital images and e-mail programs. As a result, the process for sending a digital image via e-mail involves two separate and distinct steps: 1) download, rename, and organize a digital image using the digital photo software; and 2) defining an e-mail message, attaching a digital image file to the e-mail message, specifying recipients of the e-mail message, and sending the e-mail message. Method 300 of FIG. 3 relates to the second step discussed above. First, one or more digital images are selected (step 310). An e-mail message is then created with the selected digital image(s) as attachments (step 320). The recipients of the e-mail message are then defined (step 330). Note that the recipients may be defined by individually entering each recipient, or by specifying a distribution list that includes one or more e-mail recipients. The e-mail message is then sent (step 340).

Method 200 of FIG. 2 and method 300 of FIG. 3 graphically illustrate that there is no link between digital image functions and e-mail functions in the prior art. The present invention is presented herein as a solution that provides this needed link, as discussed in detail below.

2.0 Detailed Description

The preferred embodiments provide an object recognition processor that analyzes a digital image for the presence of defined objects, such as people. When one or more defined object is recognized in the digital image, a corresponding predefined function for each defined object is performed. One example of such a predefined function is automatically generating an e-mail message that includes the digital image, and sending the e-mail message to a list of recipients that is determined by the recognized objects. Using the apparatus and methods of the preferred embodiments, people's faces may be defined as objects to search for, with a different e-mail distribution list for each defined object. Digital images may then be searched for the defined objects (people), and automatically e-mailed to the e-mail distribution list for each recognized object, resulting in an e-mail distribution list that is a superset of the e-mail distribution list for all recognized objects in the digital image.

Referring to FIG. 4, a system 400 in accordance with the preferred embodiments includes a digital image source 410 coupled to an object recognition processor 420. The digital image source 410 may be a digital camera, may be a repository of digital images (such as a floppy disk or a hard disk drive), as is intended in its broadest sense to include any suitable source of digital images. The object recognition processor 420 includes an image analyzer 430 that is used to process digital images received from the digital image source 410. The object recognition processor 420 includes one or more defined objects 440. In the preferred embodiments, defined objects 440 may include portions of digital images that are, themselves, digital images. For example, one way to define the defined objects 440 is to display an existing digital image, select a portion of the digital image, and store the selected portion as a defined object. This allows, for example, a person's face in a digital image to be stored as a defined object. Face recognition is an especially useful aspect of the preferred embodiments. Note, however, that defined objects 440 may be any suitable criteria for recognizing an object or a pattern in a digital image within the scope of the preferred embodiments.

Image analyzer 430 includes recognition logic 432 that determines when a digital image includes one or more defined objects 440. Various work has been done in the art regarding recognition logic, and any suitable recognition criteria and logic may be used within the scope of the preferred embodiments. One example of known recognition logic is Content-based Image Retrieval (CBIR), discussed in detail in a report at www.northumbria.com/iidr/research/cbir/report.html. Note that recognition logic 432 may include intelligence that allows identifying defined objects in a digital image based on processing multiple digital images. For example, let's assume that in one digital image, a small boy is running away from the camera through a sprinkler in his swimming suit. In this image, because the boy's face is not visible, the recognition logic will likely not recognize the boy as the defined object, which we assume for this example is the boy's face. However, let's also assume that the next digital image to be processed has the boy running through the sprinkler with his face visible. Recognition logic could recognize that the defined object in the second image is in proximity to a swimming suit that has a particular color pattern, and may conclude that the swimming suit in the first image corresponds to the defined object for the boy as well. Of course, many other criteria and logic may be built into the recognition logic 432 within the scope of the preferred embodiments. In addition to defined objects 440, there are also one or more defined functions 450 that are defined that correspond to the defined objects 440. When the image analyzer 430 recognizes one or more defined objects 440 in a digital image, one or more of the defined functions 450 that correspond to the recognized object(s) are performed.

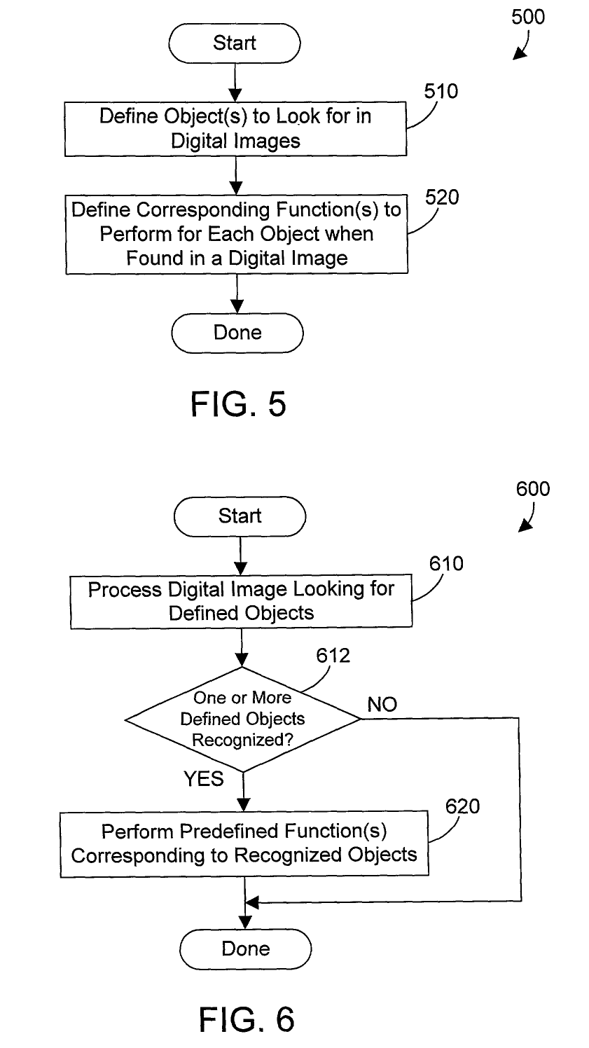

Referring to FIG. 5, a method 500 in accordance with the preferred embodiments begins by defining one or more objects to look for in digital images (step 510). Next, one or more corresponding functions are defined for the defined objects (step 520). In the preferred embodiments disclosed herein, one or more corresponding functions are defined for each defined object, but it is equally within the scope of the preferred embodiments to have defined objects with no corresponding function defined. Method 500 includes the preliminary steps that are performed before digital images can be analyzed. Once method 500 has been performed, method 600 of FIG. 6 is then performed.

The first step in method 600 is to process a digital image, looking for the defined objects (step 610). Note that step 610 includes looking for all defined objects, or looking for any suitable subset of defined objects. If one or more defined object is recognized in the digital image (step 612=YES), the predefined functions (defined in step 520 of FIG. 5) that correspond to the recognized object are performed (step 620). If no defined object is recognized in the digital image (step 612=NO), method 600 is done, and none of the predefined functions in step 620 are performed.

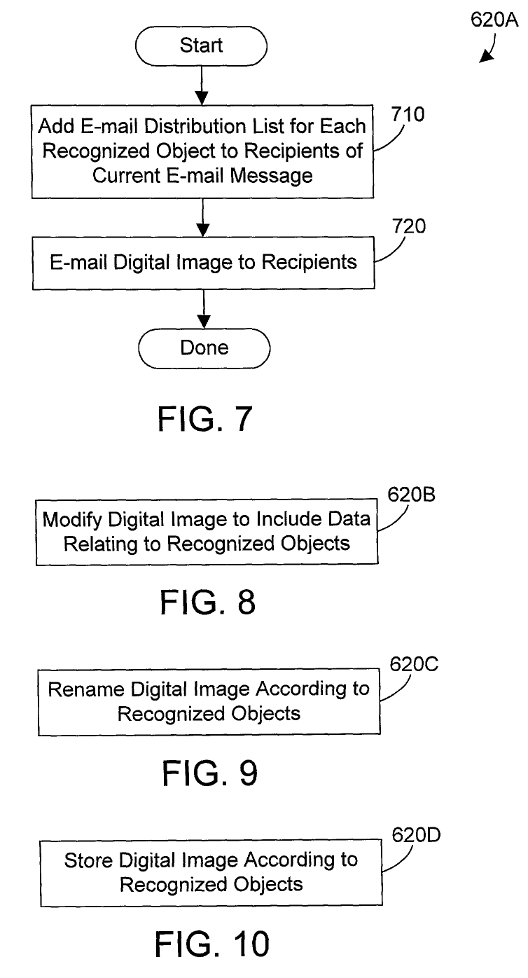

FIGS. 7-10 show some examples of steps that may be performed in step 620 of FIG. 6. In FIG. 7, method 620A assumes that e-mail distribution lists have been defined for each defined object in step 520 of FIG. 5. In step 710, the e-mail distribution list for each recognized object is added to the recipient list for a current e-mail message that includes the digital image. Note that the resulting distribution list is preferably a superset of the distribution lists for all recognized objects, so when a recipient is found in a distribution list that is already in the distribution list for the current e-mail message, the recipient is not added again to the distribution list for the current e-mail message. Once the distribution list has been compiled from the distribution lists of recognized objects, the e-mail message that includes the digital image is sent to the recipients (step 720).

Another example of step 620 in FIG. 6 is shown as step 620B in FIG. 8. One suitable function that may be performed in response to recognized objects is to modify the digital image to include data relating to the recognized objects (step 620B). Another suitable function, as shown in FIG. 9, is to rename the digital image according to the recognized objects (step 620C). This function generates names for the digital images that are more descriptive than the sequentially-assigned labels assigned by known digital cameras. Another suitable function, as shown in FIG. 10, is to store the digital image according to the recognized objects (step 620D). This function allows automatic sorting and storage of digital images that include defined objects. Thus, any digital image that includes a particular person may be stored in a directory that contains only images that contain that person. This function is thus very helpful in automatically cataloging digital images. Note that this function may include storing the digital image in multiple locations. Thus, if a digital image includes three different persons, and a directory is defined for each person that contains digital images that include that person, step 620D could store the digital image in each of the three directories.

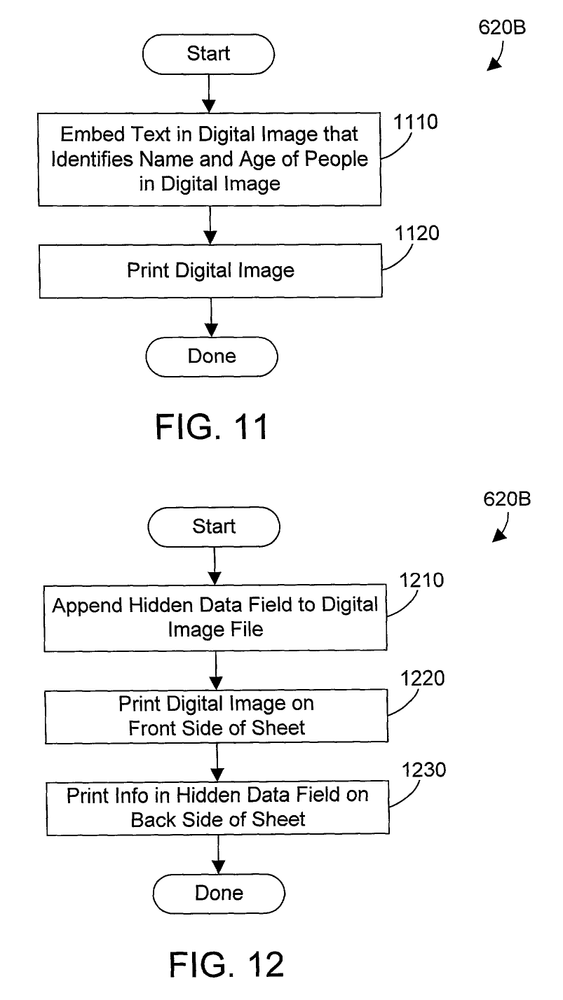

Methods 620B shown in FIGS. 11 and 12 each show steps that could be performed to modify a digital image within the scope of step 620B in FIG. 8. Referring to FIG. 11, step 1110 embeds text in the digital image that identifies name and age of the people in a digital image. This text could be located in any suitable location, such as the lower right corner of the digital image, and could be any suitable size or color. Thus, a digital image of a grandma holding her grandson Danny could be modified to show Grandma JoAnn, her age, and Danny, with his age, in the lower right hand corner of the digital image. In the alternative, a date instead of the ages (or in addition to the ages) could be included in the digital image. Note that the text would be visible in the digital image itself, and would therefore replace data in the digital image with data that would make the text visible on the digital image.

Another way to modify a digital image is to add information to a digital image that is not visible in the digital image. Referring to FIG. 12, one way to do this is to append hidden data to a digital image file (step 1210). Next, the digital image can be printed on one side of a sheet (step 1220), while the information in the hidden data field can be printed on the back side of the printed sheet (step 1230). The method of FIG. 12 thus allows automatically printing information regarding what is in a digital image on the back side of the printed digital image.

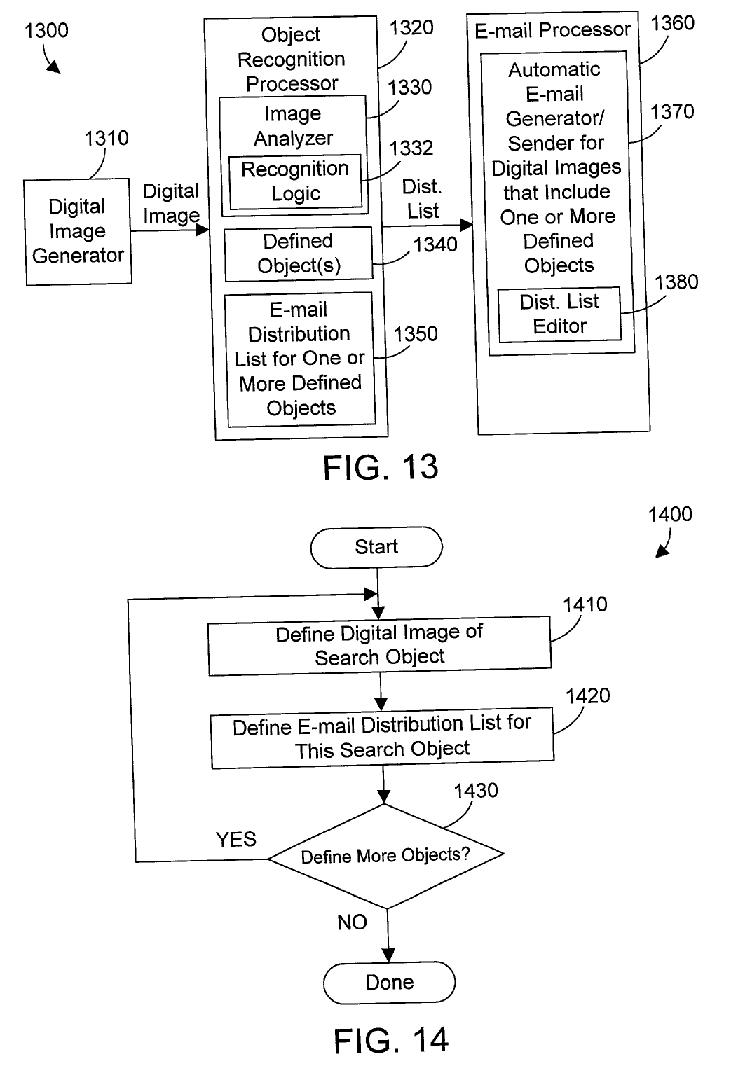

One specific example of the preferred embodiments is the automatic generation of an e-mail that includes a digital image based on objects recognized in the digital image. Such an example is shown in FIGS. 13-18. Referring to FIG. 13, a system 1300 is a more specific implementation of system 400 of FIG. 4, and includes a digital image generator 1310, an object recognition processor 1320, and an e-mail processor 1360. Digital image generator 1310 is preferably a known digital image generator, such as that known in the art of digital cameras. Object recognition processor 1320 includes an image analyzer 1330 that searches a digital image for defined objects 1340 using recognition logic 1332. In addition to the defined objects 1340, there is an e-mail distribution list 1350 for one or more of the defined objects 1340, preferably one e-mail distribution list 1350 for each defined object 1340. When the image analyzer 1330 recognizes one or more defined objects 1340 in a digital image, the object recognition processor 1320 causes the e-mail processor 1360 to automatically generate and send an e-mail message based on the recognized objects. E-mail processor 1360 includes an automatic e-mail generator/sender for digital images that include one or more defined objects 1370. Note that this generator/sender 1370 may include a distribution list editor 1380 to modify one or more distribution lists 1350 or to modify the final distribution list for the e-mail message generated by the e-mail processor 1360.

Note that system 1300 may be implemented in a single device or in multiple devices coupled together. Thus, system 1300 could be implemented within a digital camera within the scope of the preferred embodiments. In the alternative, the digital image generator 1310 may be a digital camera, with the object recognition processor 1320 and the e-mail processor 1360 comprising software running on a personal computer. Of course, the digital image generator 1310 and object recognition processor 1320 may also reside within a digital camera, while the e-mail processor 1360 is software running on a personal computer coupled to the digital camera. In addition, the digital image generator 1310, object recognition processor 1320, and e-mail processor 1360 may be implemented using any suitable combination of hardware and software. Those skilled in the art will appreciate that the object recognition processor of the preferred embodiments is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM, and transmission type media such as digital and analog communications links.

The configurations mentioned above are examples of some configurations that are within the scope of the preferred embodiments. The preferred embodiments expressly extend to any device or combination of devices that may implement the functions of system 400 in FIG. 4, or that may implement the functions of system 1300 of FIG. 13.

Referring now to FIG. 14, a method 1400 for the specific system of FIG. 13 is a specific method for the e-mail example in FIG. 13 that is within the scope of method 500 of FIG. 5. Method 1400 begins by defining a digital image of a search object (step 1410). The search object is one of the defined objects 1340 in FIG. 13, and is preferably defined by selecting a portion of an existing digital image as a search object (or defined object). For each defined object, a corresponding e-mail distribution list is also defined (step 1420). If more objects need to be defined (step 1430=YES), control passes back to step 1410, and steps 1410 and 1420 are repeated until no more objects need to be defined (step 1430=NO). Method 1400 shows the steps in creating defined objects and defining corresponding e-mail addresses for these defined objects. Thus, a face of a person could be defined as a search object (by selecting the face portion in a digital image), and an e-mail distribution list can then be defined for that face portion. This allows the object recognition processor 1320 to automatically process digital images and to automatically generate an e-mail message to specified recipients according to the contents of the digital images, as discussed in more detail below.

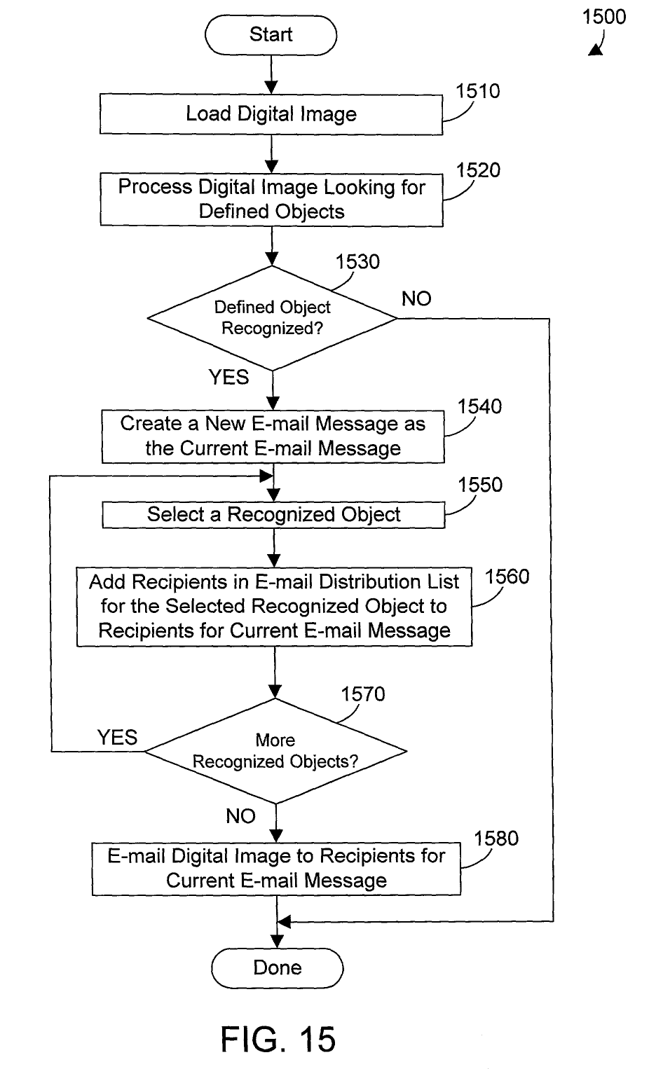

Referring now to FIG. 15, a method 1500 is a specific method for the e-mail example in FIGS. 13 and 14 that is within the scope of method 600 in FIG. 6. Method 1500 begins by loading a digital image (step 1510). Next, the digital image is processed to look for defined objects (step 1520). If no defined object is found (step 1530=NO), no further action is taken, and method 1500 is done. If, however, a defined object is recognized within the digital image (step 1530=YES), a new e-mail message is created and is designated as the current e-mail message (step 1540). Next, one of the recognized objects is selected (step 1550). The recipients in the e-mail distribution list for the selected defined object are then added to the recipients for the current e-mail message (step 1560). If there are more recognized objects to process (step 1570=YES), the next recognized object is selected (step 1550), and step 1560 is repeated. This process continues until there are no more recognized objects to process (step 1570=NO). At this point, the digital image is e-mailed to recipients for the current e-mail message (step 1580). Note that the final distribution list for the current e-mail message is a superset of all recipients in all distribution lists for all recognized objects in the digital image.

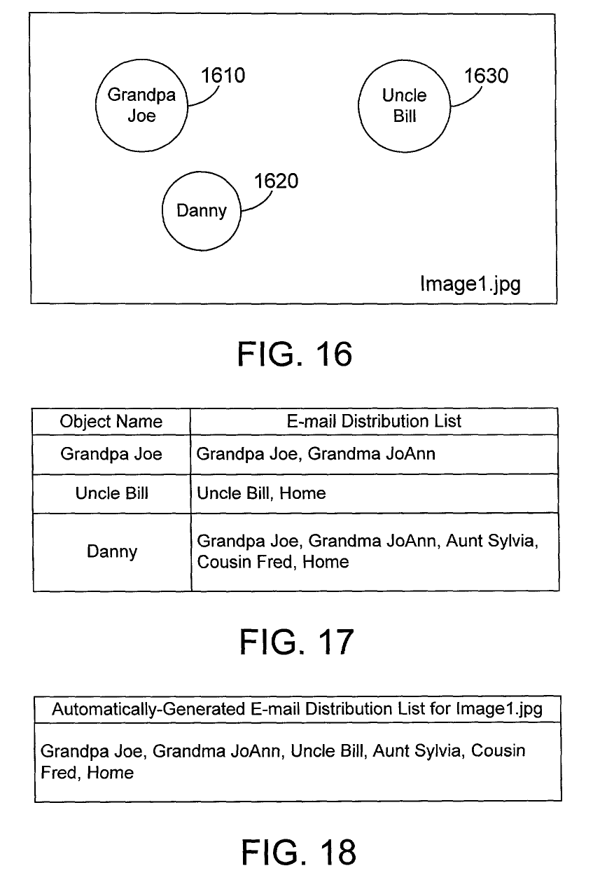

We now illustrate the function of the apparatus and methods in FIGS. 13-15 using a simple example in FIGS. 16-18. We assume that a digital image labeled Image1.jpg in FIG. 16 is a digital image that includes faces for people that correspond to defined objects called Grandpa Joe 1610, Danny 1620, and Uncle Bill 1630. The user defines the objects 1610, 1620 and 1630 in step 1410 of FIG. 14, then defines an e-mail distribution list for each defined object in step 1420. We assume that the e-mail distribution list for the three objects 1610, 1620 and 1630 in FIG. 16 are shown in FIG. 17. Note that the distribution lists include labels, such as Grandpa Joe, Uncle Bill, etc. that are commonly-used in e-mail programs to avoid the necessity of specifying an exact e-mail address (e.g., name@domain.com) as a recipient. However, explicit e-mail addresses could also be used. In the table of FIG. 17, we see that the defined object Grandpa Joe has an e-mail distribution list that includes the recipients Grandpa Joe and Grandma JoAnn. The defined object Uncle Bill has an e-mail distribution list that includes the recipients Uncle Bill and Home. The defined object Danny has an e-mail distribution list that includes the recipients Grandpa Joe, Grandma JoAnn, Aunt Sylvia, Cousin Fred, and Home.

When method 1500 of FIG. 15 is performed, first the digital image Image1.jpg in FIG. 16 is loaded in step 1510. Next, we assume that each of the defined objects 1610, 1620 and 1630 are recognized in step 1520, so step 1530=YES. A new e-mail message is then created and designated as the current e-mail message (step 1540). At this point, the distribution list for the current e-mail message is empty. Next, we assume that the Grandpa Joe object 1610 is first selected in step 1550. The recipients in the e-mail distribution list corresponding to the Grandpa Joe object are then added to the e-mail distribution list for the current e-mail message (step 1560). In other words, Grandpa Joe and Grandma JoAnn (see FIG. 17) are added to the e-mail distribution list for the current e-mail message, and because the e-mail distribution list for the current e-mail message was previously empty, Grandpa Joe and Grandma JoAnn are the only two recipients in the distribution list for the current e-mail message. There are still two more recognized objects that have not been processed (step 1570=YES). We assume that the Uncle Bill object 1630 is then selected (step 1550). The recipients in the e-mail distribution list for the Uncle Bill object (see FIG. 17) are then added to the e-mail distribution list for the current e-mail message (step 1560). As a result, the e-mail distribution list at this point in time will include Grandpa Joe, Grandma JoAnn, Uncle Bill, and Home. There is still one more recognized object to process (step 1570=YES). The Danny object 1620 is then selected (step 1550). The recipients in the e-mail distribution list for the Danny object (see FIG. 17) are then added to the e-mail distribution list for the current e-mail message (step 1560). Note that Grandpa Joe, Grandma JoAnn, and Home are already in the distribution list of the current e-mail message, so these are not added again. However, the Aunt Sylvia and Cousin Fred in the e-mail distribution list for the Danny object are added to the e-mail distribution list for the current e-mail message. At this point there are no more recognized objects to process (step 1570=NO). The resulting e-mail distribution list is shown in FIG. 18, and includes Grandpa Joe, Grandma JoAnn, Uncle Bill, Aunt Sylvia, Cousin Fred, and Home. Note that the resulting e-mail distribution list in FIG. 18 is a superset of the e-mail distribution lists for the recognized objects, shown in FIG. 17.

The preferred embodiments greatly enhance the ability to automatically perform functions based on recognized objects in a digital image. This allows automatic cataloging and storage of digital images based on their content. In addition, the present invention allows actions to be automatically performed based on the content of a digital image, such as e-mailing the digital image to a distribution list of recipients defined by the recognized objects in the digital image.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention. For example, any suitable function may be defined to correspond to a defined object, not just the defined functions presented herein. Thus, a defined object of an American Flag may have a corresponding function of generating an e-mail message that includes the digital image when an American flag is recognized, and attaching to the e-mail an audio file (such as a .wav file) of a patriotic song, such as The Star-Spangled Banner. Any suitable function of functions could be performed within the scope of the preferred embodiments when a defined object is recognized.

What is claimed is:

1. An apparatus comprising:
a memory;
at least one digital image residing in the memory;
at least one defined object residing in the memory;
an object recognition processor that analyzes a selected digital image for the presence of the at least one defined object, and that performs at least one corresponding function when the at least one defined object is recognized in the selected digital image.

2. The apparatus of claim 1 wherein the at least one defined object comprises a digital image.

3. The apparatus of claim 1 wherein the at least one corresponding function comprises an automatic e-mail function that generates an e-mail message that includes the selected digital image and that sends the e-mail message to a list of recipients determined by the at least one recognized object present in the selected digital image.

4. The apparatus of claim 1 wherein the at least one corresponding function comprises a function that modifies the selected digital image to include data relating to the at least one recognized object present in the selected digital image.

5. The apparatus of claim 4 wherein the function that modifies the selected digital image embeds text in the digital image that identifies the at least one recognized object present in the selected digital image.

6. The apparatus of claim 4 wherein the function that modifies the selected digital image adds hidden data to the digital image that corresponds to the at least one recognized object present in the selected digital image.

7. The apparatus of claim 4 further comprising a mechanism for printing the selected digital image on a first side of a two-sided sheet, and for printing the data relating to the at least one recognized object on a second side of the two-sided sheet.

8. An apparatus comprising:
a memory;
at least one digital image residing in the memory;
at least one defined object residing in the memory, wherein each defined object comprises a digital image;
an object recognition processor that analyzes a selected digital image for the presence of the at least one defined object, and, when the at least one defined object is recognized in the selected digital image, generates an e-mail message that includes the selected digital image and that sends the e-mail message to a list of recipients determined by the at least one recognized object present in the selected digital image.

9. The apparatus of claim 8 wherein each defined object has a corresponding e-mail distribution list, and where the list of recipients is a superset of the e-mail distribution lists for all recognized objects present in the selected digital image.

10. A method for processing a selected digital image comprising the steps of:
(A) defining at least one object to search for in the selected digital image;
(B) defining at least one function that corresponds to the at least one object defined in step (A);
(C) processing the selected digital image to determine if any object defined in step (A) is recognized in the selected digital image; and
(D) if any object defined in step (A) is recognized in the selected digital image, performing the at least one function defined in step (B) that corresponds to the recognized object.

11. The method of claim 10 wherein the at least one object to search for comprises a digital image.

12. The method of claim 10 wherein at least one object defined in step (A) comprises a person.

13. The method of claim 10 wherein the at least one corresponding function comprises an automatic e-mail function that generates an e-mail message that includes the selected digital image and that sends the e-mail message to a list of recipients determined by at least one recognized object present in the selected digital image.

14. The method of claim 10 wherein the at least one corresponding function comprises a function that modifies the selected digital image to include data relating to at least one recognized object present in the selected digital image.

15. The method of claim 14 wherein the function that modifies the selected digital image embeds text in the selected digital image that identifies the at least one recognized object present in the selected digital image.

16. The method of claim 14 wherein the function that modifies the selected digital image adds hidden data to the selected digital image that corresponds to the at least one recognized object present in the selected digital image.

17. The method of claim 14 further comprising the step of printing the selected digital image on a first side of a two-sided sheet.

18. The method of claim 17 further comprising the step of printing the data relating to the at least one recognized object in the selected digital image on the second side of the two-sided sheet.

19. A method for processing a selected digital image and sending the selected digital image to at least one e-mail recipient, the method comprising the steps of:
(A) defining at least one object to search for in the selected digital image;
(B) defining a list of e-mail recipients for each object defined in step (A);
(C) processing the selected digital image to determine if any object defined in step (A) is recognized in the selected digital image; and
(D) if any object defined in step (A) is recognized in the selected digital image, performing the step of generating an e-mail message that includes the selected digital image and sending the e-mail message to a list of e-mail recipients that comprises a superset of all lists of e-mail recipients for all recognized objects present in the selected digital image.

20. A program product comprising:
(A) an object recognition processor that analyzes a selected digital image for the presence of the at least one defined object, and that performs at least one corresponding function when the at least one defined object is recognized in the selected digital image; and
(B) computer-readable signal bearing media bearing the object recognition processor.

21. The program product of claim 20 wherein the computer-readable signal bearing media comprises recordable media.

22. The program product of claim 20 wherein the computer-readable signal bearing media comprises transmission media.

23. The program product of claim 20 wherein the at least one defined object comprises a digital image.

24. The program product of claim 20 wherein the at least one corresponding function comprises an automatic e-mail function that generates an e-mail message that includes the selected digital image and that sends the e-mail message to a list of recipients determined by the at least one recognized object present in the selected digital image.

25. The program product of claim 20 wherein the at least one corresponding function comprises a function that modifies the selected digital image to include data relating to the at least one recognized object present in the selected digital image.

26. The program product of claim 25 wherein the function that modifies the selected digital image embeds text in the digital image that identifies the at least one recognized object present in the selected digital image.

27. The program product of claim 25 wherein the function that modifies the selected digital image adds hidden data to the digital image that corresponds to the at least one recognized object present in the selected digital image.

28. The program product of claim 25 further comprising a mechanism for printing the selected digital image on a first side of a two-sided sheet, and for printing the data relating to the at least one recognized object on a second side of the two-sided sheet.

29. A program product comprising:
(A) an object recognition processor that analyzes a selected digital image for the presence of at least one defined object, and, when the at least one defined object is recognized in the selected digital image, generates an e-mail message that includes the selected digital image and that sends the e-mail message to a list of recipients determined by the at least one recognized object present in the selected digital image; and
(B) computer-readable signal bearing media bearing the object recognition processor.

30. The program product of claim 29 wherein the computer-readable signal bearing media comprises recordable media.

31. The program product of claim 29 wherein the computer-readable signal bearing media comprises transmission media.

32. The program product of claim 29 wherein each defined object has a corresponding e-mail distribution list, and where the list of recipients is a superset of the e-mail distribution lists for all recognized objects present in the selected digital image.
